(19) United States
(12) Patent Application Publication
(10) Pub. No.: US 2005/0257132 A1
(43) Pub. Date: Nov. 17, 2005

(54) End user customizable computer spreadsheet application based expert system

(76) Inventor: Amir Karby, Caesaria (IL)

Correspondence Address: NATH & ASSOCIATES, 1030 15th STREET, NW, 6TH FLOOR, WASHINGTON, DC, 20005, US

(21) Appl. No.: 10/526,069

(22) PCT Filed: Aug. 28, 2003
(86) PCT No.: PCT/IL03/00705

§ 371 Date: Feb. 28, 2005

Related U.S. Application Data
(60) Provisional application No. 60/406,632, filed on Aug. 29, 2002.

(51) Int. Cl. G06F 17/24

(52) U.S. Cl. 715/503

(57) ABSTRACT

The present invention provides an end user customizable computer spreadsheet application based expert system enabling end user customization without the need for the intervention of the expert system developer. The present invention achieves this objective by utilizing a commercially available computer spreadsheet application as a platform for enabling an end user to tailor spreadsheets to his particular work environment in terms of production resources, raw material resources, and also his business intelligence. Suitable commercially available computer spreadsheet applications include Microsoft XL, Corel Quattro-Pro, Lotus 1-2-3, and the like.

### FIELD OF THE INVENTION

The present invention relates to computer implemented expert systems in general, and computer implemented expert systems for providing information regarding a so-called intent to produce at least one unit of a finished product in particular.

### BACKGROUND OF THE INVENTION

Many businesses rely on computer implemented expert systems for a wide range of commercial purposes including production planning, providing cost estimations for so-called intents typically originated by customers, and the like. Computer implemented expert systems are typically customized to meet a customer's particular requirements by the expert system developer since customization requires intimate knowledge of the often thousands of lines of code making up their hard coded expert system modules. This situation is particularly problematic for print shops which typically have many different production resources, for example, printing devices, cutting devices, folding devices, and the like, and utilize many different raw material resources, for example, plates, paper, ink, and the like, to produce the wide range of different printed finished products which even relatively small print shops are expected to be able to produce for their customer base.

### SUMMARY OF THE INVENTION

The present invention provides an end user customizable computer spreadsheet application based expert system for providing information regarding an intent to produce at least one unit of a finished product including inter alia total monetary cost in terms of raw material and production costs, gross raw material requirements taking into consideration waste involved in producing a finished product, expected production run end time to produce a given net amount of a finished product, and the like. The present invention is intended to enable end user customization without the intervention of the expert system developer which is often a time consuming and costly affair by virtue of the use of a commercially available computer spreadsheet application as the platform of the expert system. The present invention can be implemented using any one of the commercially available computer spreadsheet applications such as Microsoft Excel or XL for short, Corel Quattro-Pro, Lotus 1-2-3, and the like, as the platform. Thus, an end user is readily able to design new spreadsheets, update existing spreadsheets, and the like to enable real time customization of his expert system independently of the expert system developer. The present invention can be implemented for a wide range of production facilities producing different products, and is particularly suitable for print shops to assist them in the ongoing so-called Print-on-Demand (POD) revolution requiring them to cope with ever greater numbers of relatively small production runs within for ever shorter turnaround times.

The foregoing and other features and advantages of the invention will be apparent from the following more particular description of preferred embodiments of the present invention as illustrated in the accompany drawings in which similar parts are likewise numbered.

### BRIEF DESCRIPTION OF THE DRAWINGS

FIG. 1 is a block diagram of a general purpose computer system for executing an end user customizable computer spreadsheet application based expert system in accordance with the present invention,

FIG. 2 is a graphic representation showing the generation of unified spreadsheets in accordance with the present invention;

FIG. 3 is a graphic representation showing the chaining of production information items between linked end user editable spreadsheets of a unified spreadsheet;

FIG. 4 is a graphical representation of a product description graph representing a demonstration kit consisting of a fold out brochure with CD sleeve for receiving a labeled CD;

FIG. 5 is a pictorial representation of the demonstration kit;

FIGS. 6A and 6B are graphical representations of exemplary Class A production paths for producing Class A paper components;

FIG. 7 is a graphical representation of a Class A production sequence for producing the demonstration kit's fold out brochure with CD sleeve;

FIG. 8 is a pictorial representation of a Class A production concept spreadsheet block for modeling the production of Class A paper components;

FIG. 9 is a pictorial representation of a Class B production concept spreadsheet block for modeling the integration of Class B integrated components;

FIGS. 10A, 10B, 10C, and 10D are graphical representations of exemplary Class B production paths for integrating Class B integrated components;

FIG. 11 is a pictorial representation of a Class C production concept spreadsheet block for modeling the production of Class C non-paper components;

FIGS. 12A and 12B are graphical representations of exemplary Class C production paths for producing Class C non-paper components;

FIG. 13 is a pictorial representation of a resource spreadsheet block for parameterizing an offset printer;

FIG. 14 is a pictorial representation of a resource spreadsheet block for parameterizing a digital printer;

FIG. 15 is a block diagram of the end user customizable computer spreadsheet application based expert system in accordance with the present invention;

FIG. 16 is a top level flow diagram of the operation of the end user customizable computer spreadsheet application based expert system in accordance with the present invention;

FIG. 17 is a graphical representation of the unified ITP spreadsheet for fulfilling an intent for FIG. 5's demonstration kit;

FIG. 18 is a graphical representation of a production flow graph for fulfilling an intent for FIG. 5's demonstration kit; and

FIG. 19 is a graphical representation of an alternative production flow graph for fulfilling an intent for FIG. 5's demonstration kit.

### DETAILED DESCRIPTION OF PREFERRED EMBODIMENTS

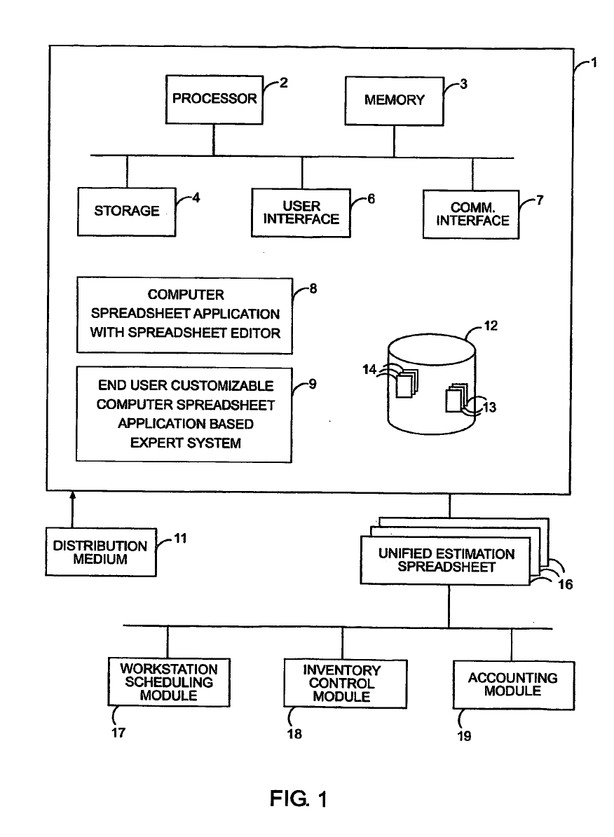

FIG. 1 shows a general purpose computer system 1 including a processor 2, system memory 3, non-volatile storage 4, a user interface 6 including a keyboard, a mouse, a display, and the like, and a communication interface 7. The constitution of each of these elements is well known and each performs its conventional function as known in the art and accordingly will not be described in greater detail. In particular, the system memory 3 and the non-volatile storage 4 are employed to store a working copy and a permanent copy of the programming instructions implementing the present invention. The computer system 1 is capable of running a computer spreadsheet application 8 with a spreadsheet editor, and an end user customizable computer spreadsheet application based expert system 9 suitable for use in a production facility. The permanent copy of the programming instructions to practice the present invention may be loaded into the non-volatile storage 4 in the factory, or in the field, through communication interface 7, or through distribution medium 11. The permanent copy of the programming instructions is capable of being distributed as a program product in a variety of forms, and the present invention applies equally regardless of the particular type of signal bearing media used to carry out distribution. Examples of such media include recordable type media e.g. CD ROM and transmission type media e.g. digital communication links.

The expert system 9 includes a spreadsheet database 12 storing end user editable spreadsheet blocks each relating to a particular class of an object, and including at least one input spreadsheet cell each associated with an input parameter selected by an end user from a plurality of input parameters, at least one output spreadsheet cell each associated with an output parameter selected by an end user from a plurality of output parameters, and at least one spreadsheet script for receiving input values from at least one input spreadsheet cell, computing output values of at least one end user selected output parameter, and returning output values to their associated output spreadsheet cells. The present invention includes two objects as follows: A first object relating to a finished product both in terms of its components and the production processes required to produce same. And second, a second object relating to resources available for producing a finished product. Thus, the spreadsheet database 12 preferably includes so-called production resource spreadsheet blocks 13 for modeling the production of the different components of different finished products, and so-called resource spreadsheet blocks 14 for parameterizing production resources and raw material resources available for producing a finished product. It should be noted that each spreadsheet block is preferably provided as a discrete spreadsheet file so that the files are more manageable for purposes to become apparent hereinbelow, however, the entire spreadsheet blocks required to implement the present invention can be clustered in different regions of a single spreadsheet file.

The expert system 9 is intended to output unified estimation spreadsheets 16 which can be input to auxiliary modules, for example, a workstation scheduling module 17, an inventory control module 18, accounts module 19, and the like. Each unified estimation spreadsheet 16 is intended to provide information regarding an intent to produce at least one unit of a finished product, for example, total monetary cost in terms of raw material and production costs, raw material requirements taking into consideration waste, and the like. Each unified estimation spreadsheet 16 has a so-called production plan space which defines the values of parameters for which the same spreadsheet may be employed, thereby negating the need for entering a new intent in the case of a relatively simple change in its originating intent, say, an increase in a net amount from 10 to 20. Conversely, any change beyond the production plan space of a unified estimation spreadsheet automatically behooves the entry of a new intent.

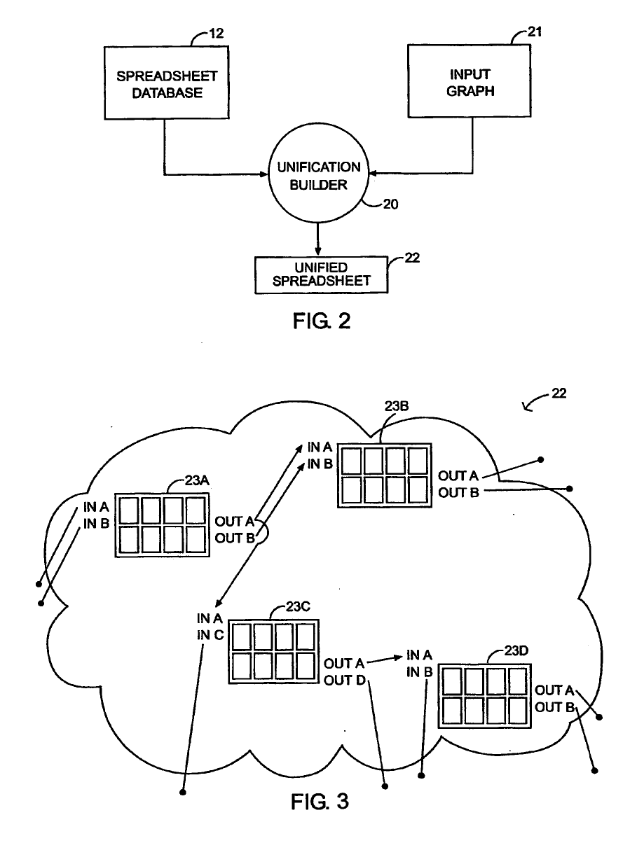

FIG. 2 shows that a hard coded unification builder 20 interfaces with the spreadsheet database 12 to selectively link at least two end user editable spreadsheet blocks in accordance with an input graph 21 determined in accordance with an intent to produce at least one unit of a finished product to generate one or more unified spreadsheets 22 enabling the chaining of production information items between their constituent end user editable spreadsheets. FIG. 3 shows that the unified spreadsheet 22 has spreadsheet blocks 23 with input spreadsheet cells receiving input values from either external sources or output spreadsheet cells of other spreadsheet blocks, and spreadsheet blocks 23 with output spreadsheet cells providing output values to either external sources or input spreadsheet cells of other spreadsheet blocks. For example, the spreadsheet block 23A receives external input values In A and In B and provides the output value Out A to the spreadsheet blocks 23B and 23C and output value Out B to the spreadsheet block 23C. Whilst the spreadsheet block 23D receives the input value In A from the spreadsheet block 23C and the external input value In B and provides output values Out A and Out B. This chaining of production information items is essential to enable calculations which are dependent on the entire production sequence for producing a finished product, for example, raw material requirements, total cost, and the like. Most production information items are backward calculated starting off from an end value, for example, net amount to be supplied whilst others, for example, the weight of a finished product, are forward calculated starting off from several initial values. It should be noted that a spreadsheet script may include an end user defined intermediate parameter having a computed value in accordance with a given set of input values which is capable of being manually overwritten by an end user.

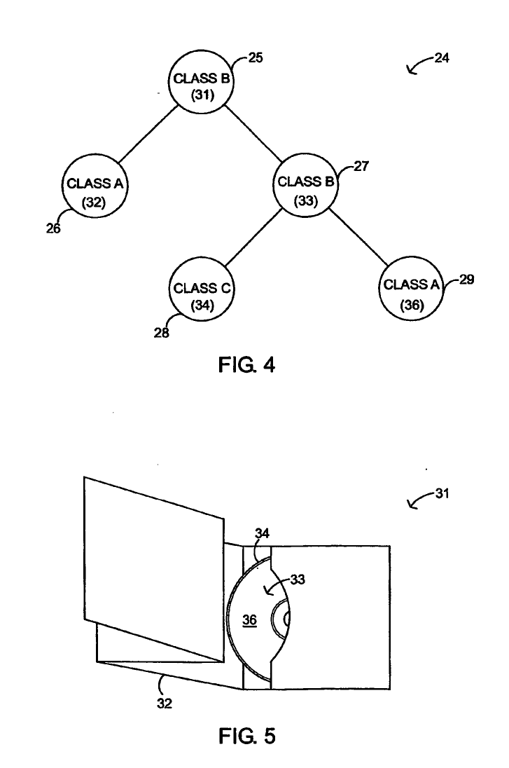

For the purposes of exposition, the present invention is now described with respect to an end user customizable computer spreadsheet application based expert system for a print workshop for producing printed finished products, for example, demonstration kits including a fold out brochure and a CD, stock certificates, catalogues, wedding invitations, and the like. Each printed finished product is represented by a tree-like product description graph (constituting an input graph) having a single root node typically furcated to two or more branches except in the case of a single printed document. Each branch may terminate in a leaf node or itself be furcated at a node representing a product which is a component of a higher product into two or more branches. Each branch finally terminates in one or more leaf nodes. Leaf nodes are classified as being in one of two classes: Class A leaf nodes and Class C leaf nodes. The former represent so-called paper components, for example, a printed page, a collection of identical printed pages differing only in their content, and the like. The latter represent non-paper components for integration into a printed finished product, for example, a CD, a spiral binder, a plastic cover, and the like. Class B non-leaf nodes represent integrated components, namely, components consisting of at least one single printed component and/or at least one integrated component and/or at least one non-paper component. FIG. 4 shows a product description graph 24 representing a demonstration kit 31 consisting of a fold out brochure with CD sleeve 32 for receiving a labeled CD 33 consisting of a CD 34 and a label 36 (see FIG. 5). The product description graph 24 includes a Class B root node 25 representing the demonstration kit 31, a Class A leaf node 26 representing the fold out brochure 32, a Class B non-leaf node 27 representing the labeled CD 33, a Class C leaf node 28 representing the CD 34, and a Class A leaf node 29 representing the label 36.

End User Customization of the Expert System

End user customization of the expert system 9 involves analysis of the printed finished products that a print shop manager wishes to produce for his customer base in the light of the production and raw material resources at his disposal, and the editing of production concept spreadsheet blocks 13 and resource spreadsheet blocks 14.

The expert system 9 includes a production concept spreadsheet block 13 for each of the three different classes Class A, Class B, and Class C each including a collection of production paths which may be potentially employed for producing one or more of the components of its particular class which the print shop manager intends to produce. Very rarely will the production of a component require all the production processes along a particular production path or, in other words, most if not all production paths include one or more production processes which are not required to produce any particular component. Moreover, two or more production paths may contain the same production processes but their order may differ. For example, one possible Class A production path may have laminating before printing whilst another may have printing before laminating.

In greater particularity, the print shop manager performs the following analysis with respect to the Class A paper components:

(1) He compiles a list of all the Class A paper components, for example, a fold out brochure, a printed page, a collection of identical printed pages only differing in their content, and the like, which he intends to produce.

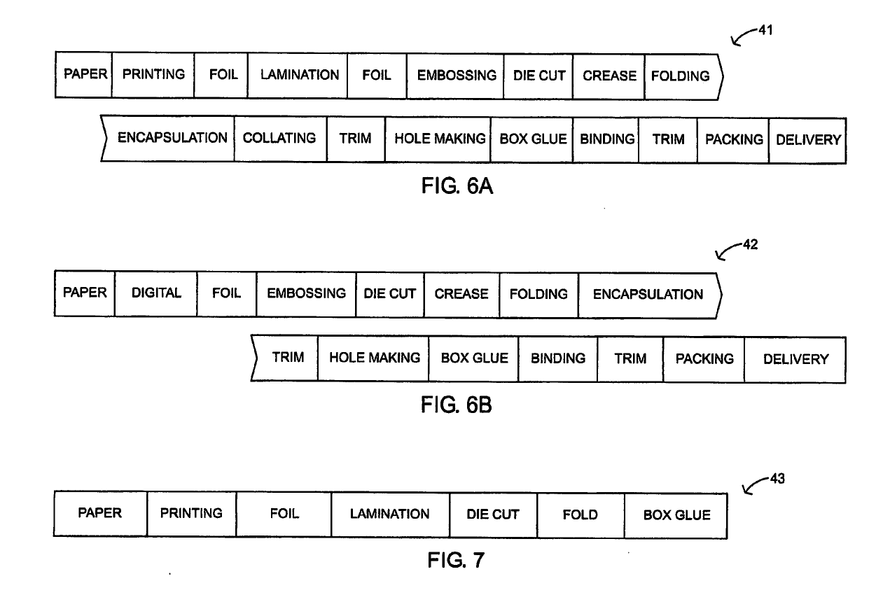

(2) He determines different Class A production paths for producing the Class A paper components which he intends to produce. Each Class A production path starts from raw material and terminates in the delivery of a finished item. FIGS. 6A and 6B show exemplary Class A production paths 41 and 42.

(3) He selects a sub-set of the Class A production paths suitable for producing each Class A paper component in general, and the production processes for producing each Class A paper component in particular. For example, a print shop manager may decide that the most suitable Class A production sequence denoted 43 in FIG. 7 to produce the fold out brochure 32 includes the 1^{st}, 2nd, 3rd, 4th, 7^{th}, 9^{th}, and 14^{th} production processes of the Class A production path 41.

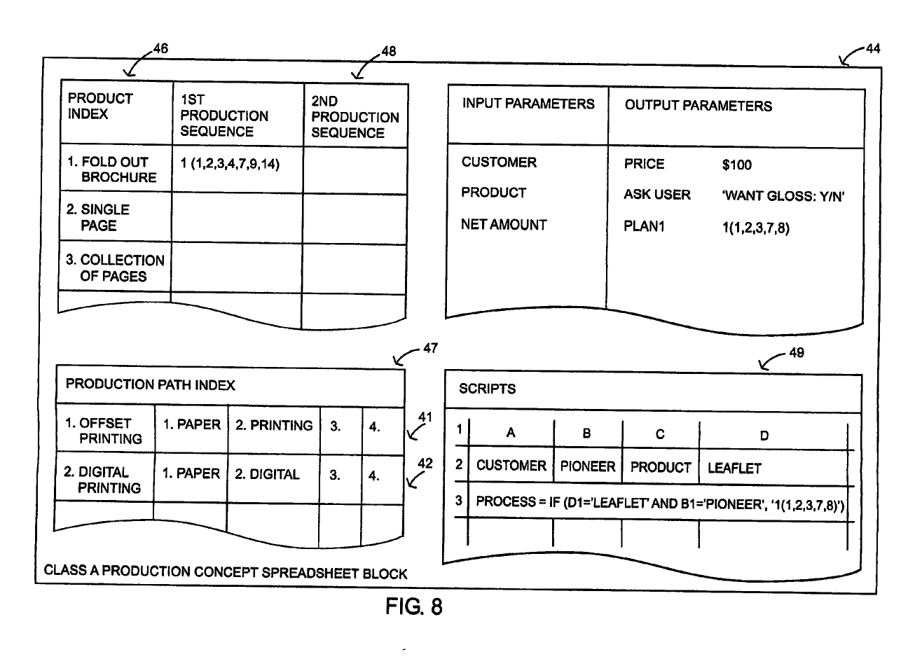

The print shop manager invokes the spreadsheet editor and edits a Class A production concept spreadsheet block 44 (see FIG. 8) to reflect the above information as follows. He edits an index of the Class A paper components 46 that he wants to produce, and an index of possible Class A production paths 47 and lists their production processes. The print shop manager then edits the production processes of each suitable Class A production path for each of the Class A paper components to determine Class A production sequences 48. The print shop manager may edit Class A spreadsheet scripts 49 for flagging certain production processes depending on the values of certain input parameters. The spreadsheet scripts typically involve one or more IF/THEN conditions, and may invoke another spreadsheet script, and the like. For example, a customer PIONEER may instruct the print shop manager that they want all their products digitally printed. Or, a print shop manager may decide that he prefers the Class A production path 42 for intents specifying a Net Amount of >1000 demonstration kits. A production concept spreadsheet may include instructions for user prompts for assisting in the entry of a new intent for a finished product, for example, ASK USER ‘WANT GLOSS: Y/N’.

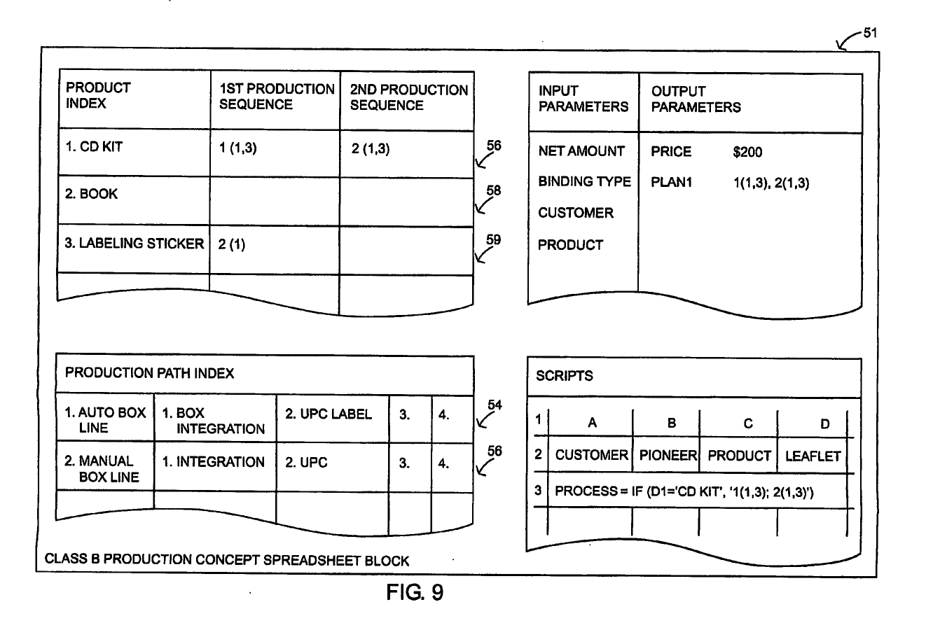

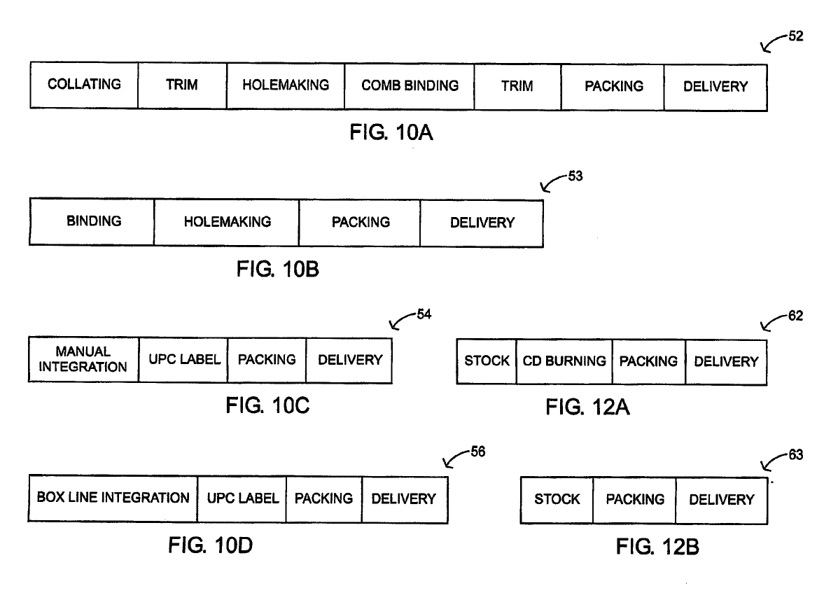

The print shop manager repeats the above steps for Class B integrated components to arrive at a Class B production concept spreadsheet block 51 (see FIG. 9). The Class B production concept spreadsheet block 51 includes exemplary Class B production paths 52 and 53 for producing books (see FIGS. 10A and 10B), an exemplary Class B production path 54 for manually integrating a CD in a printed document (see FIG. 10C), and an exemplary Class B production path 56 for automatically integrating a CD in a printed document (see FIG. 10D). The Class B production concept spreadsheet block 51 also includes a Class B production sequence 57 for producing a CD kit, a Class B production sequence 57 for producing a book, and a Class B production sequence 58 for producing a labeled sticker.

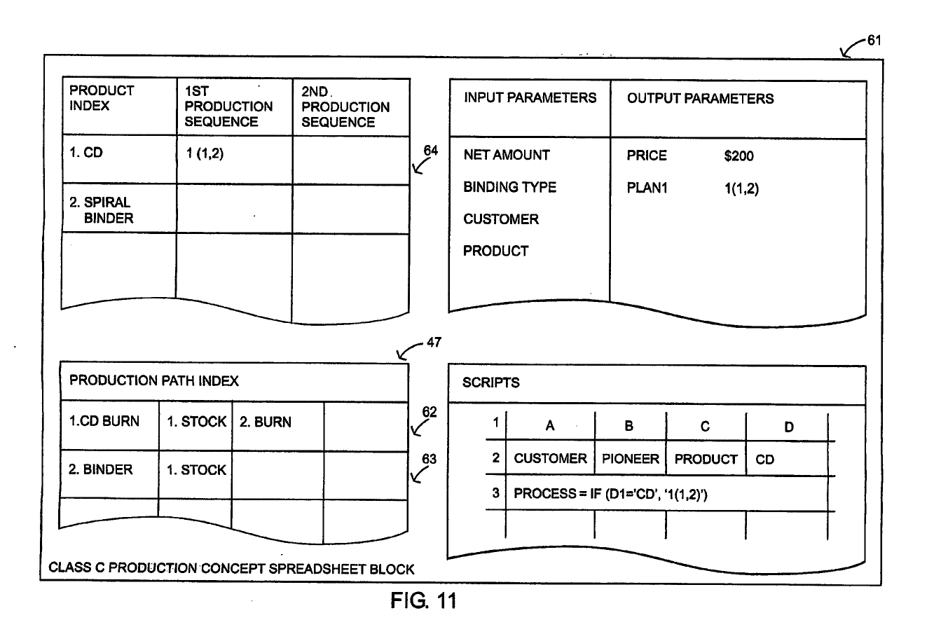

The print shop manager repeats the above steps for Class C integrated components to arrive at a Class C production concept spreadsheet block 61 (see FIG. 11) The Class C production concept spreadsheet block 61 includes an exemplary Class C production path 62 for preparing a CD (see FIG. 12A); and an exemplary Class B production path 63 for a non-paper product that can be integrated into a finished product (see FIG. 12B). The Class C production concept spreadsheet block 61 also includes a Class B production sequence 64 for producing a CD kit.

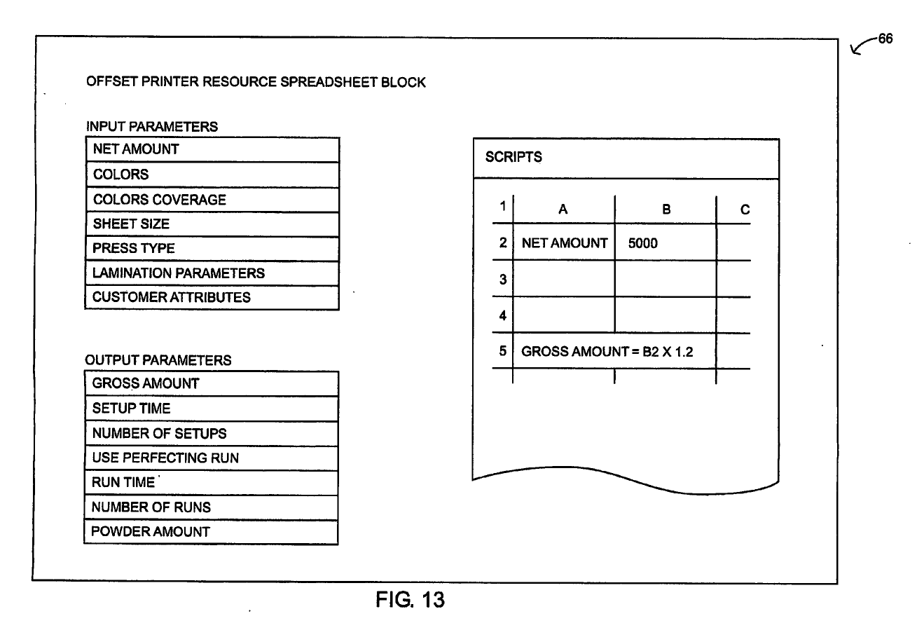

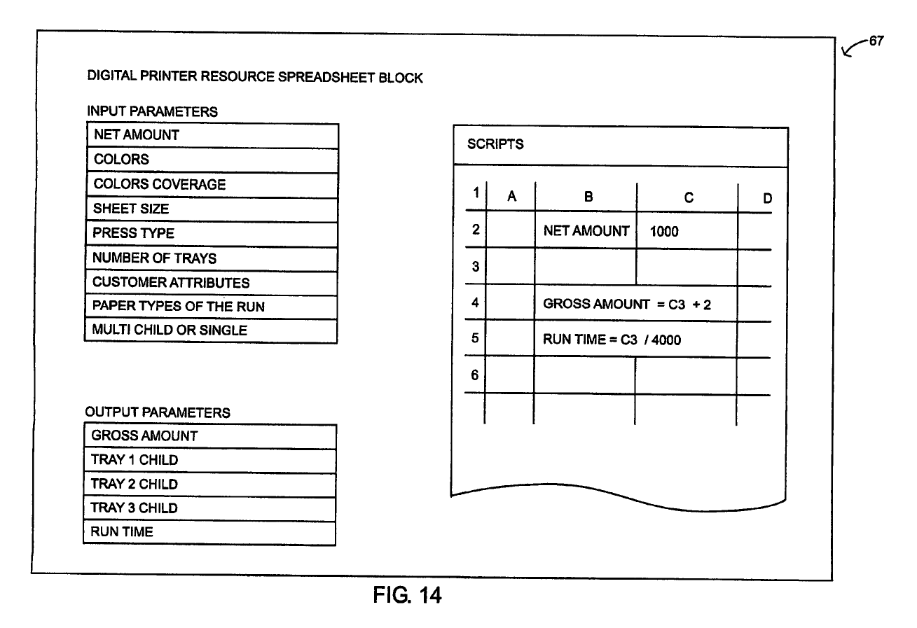

The expert system 9 includes a resource spreadsheet block 14 for each production resource class and each raw material resource class, namely, the expert system 9 includes resource spreadsheet blocks 14 for folding devices, cutting devices, collating devices, and the like, and resource spreadsheet blocks 14 for inks, plates, paper, and the like. The print shop manager edits resource spreadsheet blocks 14 in a similar manner to the production concept spreadsheet blocks 13 but in this case each resource spreadsheet block 14 has a list or predetermined input parameters and a list of predetermined output parameters for parameterizing a resource. Different resource spreadsheet blocks pertaining to different resources may include the same input parameter, for example, NET AMOUNT, whilst some resourced spreadsheet blocks may include input parameters specific to its particular type of resource. The print shop manager edits spreadsheet scripts also in a similar manner as before. FIGS. 13 and 14 show resource spreadsheet blocks 66 and 67 for an offset printer and a digital printer, respectively.

Description of Expert System

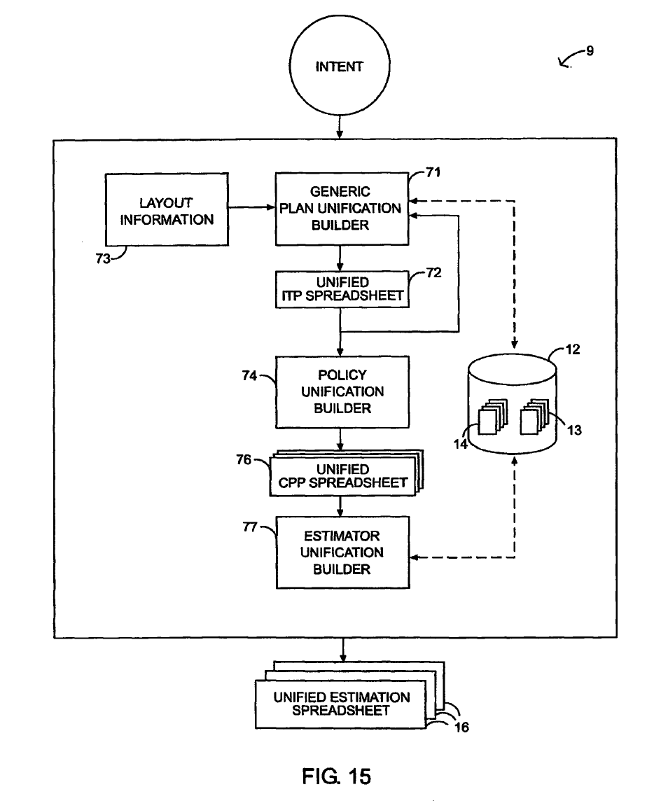

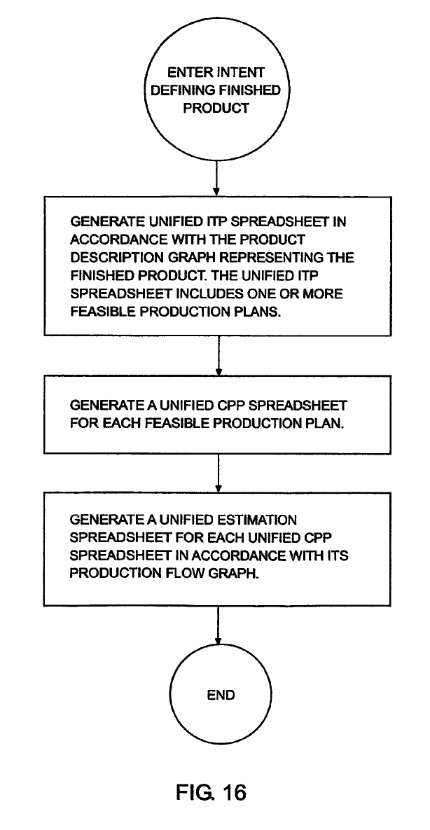

The end user customizable computer spreadsheet application based expert system 9 includes the following hard coded unification builders (see FIG. 15):

A generic plan unification builder 71 for receiving the product description graph representing the finished product determined by an intent and selectively linking the Class A, Class B and Class C production concept spreadsheet blocks 13 in accordance therewith to generate a so-called unified Intent To Production (ITP) spreadsheet 72. The unified ITP spreadsheet 72 includes all the theoretical production options for producing each and every one of the Class A paper components, Class B integral components, and Class C non-paper components required to produce a finished product. Since the number of theoretical production options can reach several million options for even a relatively simple printed finished product, impractical theoretical production options are preferably eliminated and others are rated using a rating scheme forming part of a spreadsheet block's parameters to preferably reduce the number of theoretical production options to a few feasible production plans.

The generic plan unification builder 71 also receives input in the form of layout information 73 since impositioning can considerably effect the production options available to produce a printed component and in turn be effected by it. Layout information can be input by a print shop manager interactively or alternatively it can be input automatically. A policy unification builder 74 for receiving an intent's ITP spreadsheet 72 and generating a unified Coarse Production Plan (CPP) spreadsheet 76 for each of the unified ITP spreadsheet's feasible production plans. Each unified CPP spreadsheet 76 specifies a production flow graph (constituting an input graph) of production processes starting from raw materials and terminating in the finished product determined by an intent in question.

An estimator unification builder 77 for receiving an intent's one or more unified CPP spreadsheets 76 and linking resource spreadsheets 14 for generating at least one unified estimation spreadsheet 16 for each unified CPP spreadsheet 76.

Operation of Expert System

The operation of the expert system 9 is now described for fulfilling an intent for producing 1000 demonstration kits 31. An originator enters the intent by way of a suitable Graphic User Interface (GUI), for example, drag and drop. The initiator includes all relevant information regarding the demonstration kits in terms of net amount, brochure size, brochure paper weight, brochure printing quality, and the like.

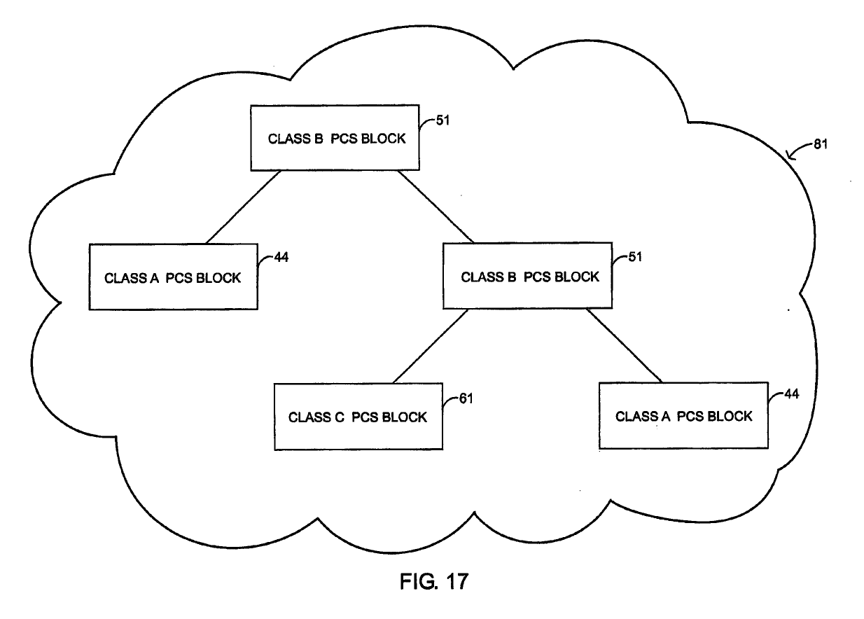

The generic plan unification builder 71 receives the product description graph 24 and links the Class A production concept spreadsheet block 44, the Class B production concept spreadsheet block 51 and the Class C production concept spreadsheet block 61 to generate a unified Im spreadsheet 81 (see FIG. 17) having a total of, say, two feasible production plans. For example, the first feasible production plan involves manual integration of the CD 34 in the demonstration kit 31 whilst the second feasible production plan includes automatic integration.

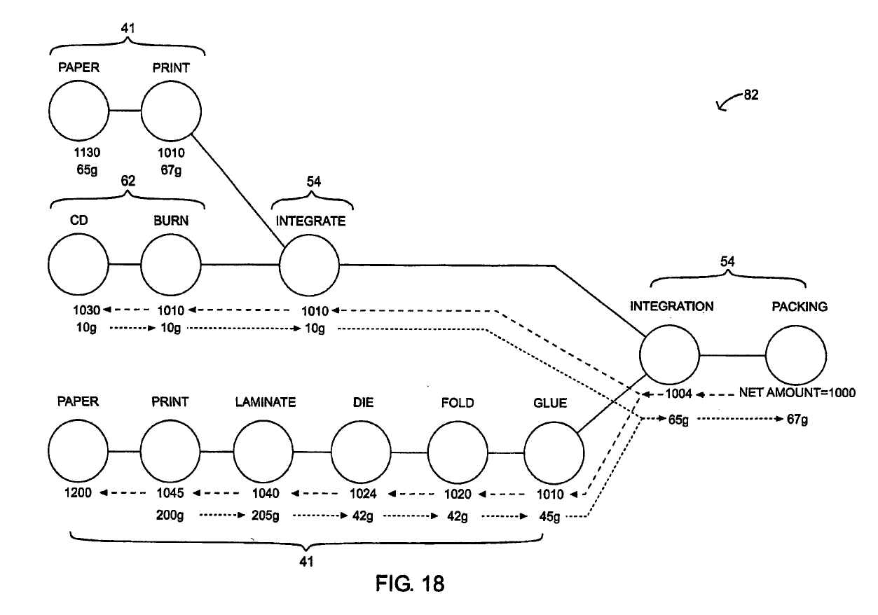

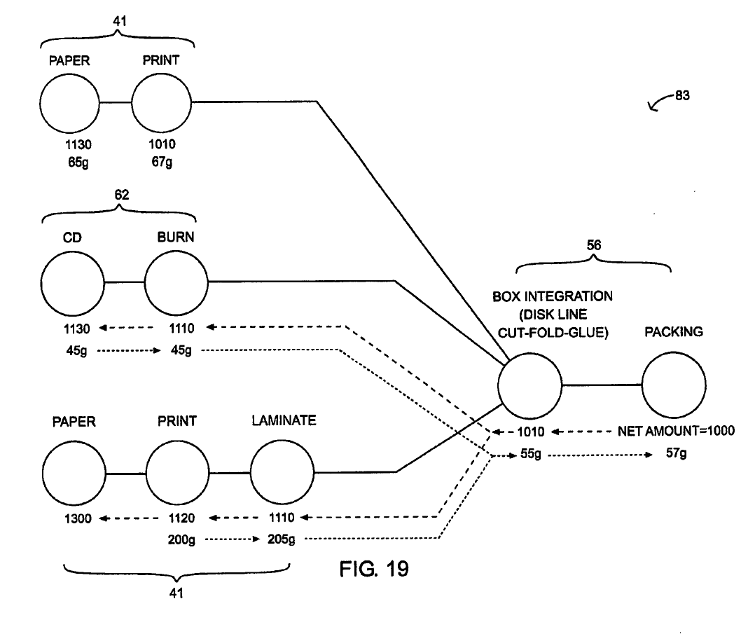

The policy unification builder 74 receives the unified ITP spreadsheet 81 and generates two unified CPP spreadsheets each specifying a different production flow graph 82 and 83 corresponding to the feasible production plans (see FIGS. 18 and 19). The production flow graph 82 includes sequences from production paths 41, 54 and 62. The production flow graph 83 includes sequences from production paths 41, 56 and 62.

The estimator unification builder 77 receives the two unified CPP spreadsheets and links the appropriate resource spreadsheet blocks 14 to generate unified estimation spreadsheets providing production information to assist the print shop manager to decide which production flow graph 82 or 83 is preferable. For illustrative purposes, the production flow graphs 82 and 83 show the gross amounts of raw material required to produce 1000 demonstration kits and weight calculations. As shown, in this case, the production flow graph 82 leads to less wastage of CDs, namely, 1030 as opposed to 1130 in the case of the production flow graph 83, however, the total production time may be far longer.

While the invention has been described with respect to a limited number of embodiments, it will be appreciated that many variations, modifications, and other applications of the invention can be made within the scope of the appended claims. It should be noted that a degenerate version of the end user customizable computer spreadsheet application based expert system of the present invention may include only a single unification builder for generating either a unified ITP spreadsheet or a unified estimation spreadsheet.

1. End user customizable computer spreadsheet application based expert system for providing information regarding an intent to produce at least one unit of a finished product, the system comprising:
(a) at least one spreadsheet each with at least one end user editable spreadsheet block each relating to a particular class of an object and having:
i) at least one input spreadsheet cell each associated with an input parameter selected by an end user from a plurality of input parameters,
ii) at least one output spreadsheet cell each associated with an output parameter selected by an end user from a plurality of output parameters, and
iii) at least one spreadsheet script for receiving input values from at least one input spreadsheet cell, computing output values of at least one end user selected output parameter, and returning output values to their associated output spreadsheet cells; and
b) a hard coded unification builder for selectively linking at least two spreadsheet blocks in accordance with an input graph determined in accordance with the intent to generate at least one unified spreadsheet enabling the chaining of at least one production information item between a pair of its constituent spreadsheet blocks.

2. The system according to claim 1 wherein said object relates to the construction of finished products, and said unification builder links at least two spreadsheet blocks in accordance with a product description graph logically representing the finished product to generate at least one unified Intent To Production (ITP) spreadsheet including at least one feasible production plan for fulfilling the intent.

3. The system according to claim 2 wherein a spreadsheet block includes instructions for user prompts for assisting in the entry of an intent.

4. The system according to claim 1 wherein said object relates to resources available to produce finished products, and said unification builder links at least two spreadsheet blocks in accordance with a production flow graph of production processes starting from raw materials and terminating in the finished product to generate a unified estimation spreadsheet for fulfilling the intent.

5. The system according to claim 1 wherein a spreadsheet script defines an end user defined intermediate parameter having a computed value in accordance with a given set of input values which is capable of being manually overwritten by an end user.

6. The system according to claim 1 wherein the end user customizable computer spreadsheet application based expert system is designed for providing information regarding an intent for producing at least one unit of a printed finished product and is capable of receiving impositioning information regarding its printed components.

7. The system according to claim 6 wherein the end user customizable computer spreadsheet application based expert system includes a first spreadsheet block for modeling the production of paper components of a printed finished product, a second spreadsheet block for modeling the production of non-paper components of a printed finished product, and a third spreadsheet block for modeling the integrating of at least one paper component and/or at least one integrated component and/or at least one non-paper component.

8. Method of operation of an end user customizable computer spreadsheet application based expert system for providing information regarding the production of a product, the method comprising the steps of:
(a) providing at least one end user editable spreadsheet each with at least one spreadsheet block each relating to a particular class of an object and having:
i) at least one input spreadsheet cell each associated with an input parameter selected by an end user from a plurality of input parameters,
ii) at least one output spreadsheet cell each associated with an output parameter selected by an end user from a plurality of output parameters, and
iii) at least one spreadsheet script for receiving input values from at least one input spreadsheet cell, computing output values of at least one end user selected output parameter, and returning output values to their associated output spreadsheet cells; and
(b) selectively linking at least two spreadsheet blocks in accordance with an input graph determined in accordance with the intent to generate at least one unified spreadsheet enabling the chaining of at least one production information item between a pair of its constituent spreadsheet blocks.

9. The method according to claim 8 wherein the object relates to the construction of finished products, and step (b) includes linking at least two spreadsheet blocks in accordance with a product description graph logically representing the finished product to generate at least one unified Intent To Production (ITP) spreadsheet including at least one feasible production plan for fulfilling the intent.

10. The method according to claim 9 wherein a spreadsheet block includes instructions for user prompts for assisting in the entry of an intent.

11. The method according to claim 8 wherein the object relates to resources available to produce finished products, and step (b) includes linking at least two spreadsheet blocks in accordance with a production flow graph of production processes starting from raw materials and terminating in the finished product to generate a unified estimation spreadsheet for fulfilling the intent.

12. The method according to claim 8 wherein a spreadsheet script defines an end user defined intermediate parameter having a computed value in accordance with a given set of input values which is capable of being manually overwritten by an end user.

13. The method according to claim 8 wherein the end user customizable computer spreadsheet application based expert system is designed for providing information regarding an intent for producing at least one unit of a printed finished product and is capable of receiving impositioning information regarding its printed components.

14. The method according to claim 13 wherein the end user customizable computer spreadsheet application based expert system includes a first spreadsheet block for modeling the production of paper components of a printed finished product, a second spreadsheet block for modeling the production of non-paper components of a printed finished product, and a third spreadsheet block for modeling the integrating of at least one paper component and/or at least one integrated component and/or at least one non-paper component.

15. A distribution medium for distributing a computer program comprising instructions which, when executed by a computer, perform the steps of
(a) providing at least one end user editable spreadsheet block each relating to a particular class of an object and having:
i) at least one input spreadsheet cell each associated with an input parameter selected by an end user from a plurality of input parameters,
ii) at least one output spreadsheet cell each associated with an output parameter selected by an end user from a plurality of output parameters, and
iii) at least spreadsheet script for receiving input values from at least one input spreadsheet cell, computing output values of at least one end user selected output parameter, and returning output values to their associated output spreadsheet cells; and
b) providing a hard coded unification builder for selectively linking at least two spreadsheet blocks in accordance with an input graph determined in accordance with the intent to generate at least one unified spreadsheet enabling the chaining of at least one production information item between a pair of its constituent spreadsheet blocks.

16. The medium according to claim 15 wherein said object relates to the construction of finished products, and said unification builder links at least two spreadsheet blocks in accordance with a product description graph logically representing the finished product to generate at least one unified Intent To Production (ITP) spreadsheet including at least one feasible production plan for fulfilling the intent.

17. The medium according to claim 16 wherein a spreadsheet block includes instructions for user prompts for assisting in the entry of an intent.

18. The medium according to claim 15 wherein said object relates to resources available to produce finished products, and said unification builder links at least two resource spreadsheet blocks in accordance with a production flow graph of production processes starting from raw materials and terminating in the finished product to generate a unified estimation spreadsheet for fulfilling the intent.

19. The medium according to claim 15 wherein a spreadsheet script defines an end user defined intermediate parameter having a computed value in accordance with a given set of input values which is capable of being manually overwritten by an end user.

20. The medium according to claim 15 wherein the end user customizable computer spreadsheet application based expert system is designed for providing information regarding an intent for producing at least one unit of a printed finished product and is capable of receiving impositioning information regarding its printed components.

21. The medium according to claim 20 wherein the end user customizable computer spreadsheet application based expert system includes a first spreadsheet block for modeling the production of paper components of a printed finished product, a second spreadsheet block for modeling the production of non-paper components of a printed finished product, and a third spreadsheet block for modeling the integrating of at least one paper component and/or at least one integrated component and/or at least one non-paper component.
